(19) United States
(12) Patent Application Publication
(10) Pub. No.: US 2016/0139649 A1
(43) Pub. Date: May 19, 2016

(54) PERFORMANCE-ADJUSTABLE MEMORY MODULE

(71) Applicant: Moon J. Kim, Wappingers Falls, NY (US)

(72) Inventor: Moon J. Kim, Wappingers Falls, NY (US)

(21) Appl. No.: 13/652,500

(22) Filed: Oct. 16, 2012

(51) Int. Cl. G06F 1/32; G06F 3/06

(52) U.S. Cl. CPC G06F 1/3275; G06F 3/0625; G06F 3/0629; G06F 3/0673; G06F 3/0611

(57) ABSTRACT

A performance-adjustable memory module configured for power consumption optimization is provided. In a typical approach, the memory module (e.g., a DRAM-type memory module) comprises a set of memory segments coupled to a set of power supplies. A controller (e.g., an external controller) will supply control information via a set of control registers that is used to vary levels of power provided by the set of power supplies to the set of memory segments. The varying levels of power allow for the performance levels of the set of memory segment to be varied, and thus provide a more optimized memory system.

### FIELD OF THE INVENTION

Embodiments of the present invention relate to memory architectures. Specifically, embodiments of the present invention relate to performance-adjustable memory modules (e.g. DRAMs) configured for power consumption optimization.

### BACKGROUND OF THE INVENTION

Current mobile systems suffer from power leakage and consumption of semiconductor circuits. Moreover, current low-power circuits are based on conventional design schemes. However, mobile multi-core processor (MCP) implementations require a fundamentally different design approach for cores and on-chip memories. Still yet, current memory approaches are based on standard-based fixed speed having a fixed power supply. In some implementations, a sleep mode may be present. However, the sleep mode may take an extensive period of time for the memory to transition between sleep and wake modes.

Typically, existing memory configurations rely on standards-based fixed speed (e.g., fixed response latency and data rate). Moreover, current power supply levels are typically fixed by a standard as well. As such, varying levels of performance and/or power consumption are difficult to achieve/optimize. In such instances, it may take extended periods of time to switch between memory modes (e.g., from a sleep mode to an active mode).

### SUMMARY OF THE INVENTION

In general, embodiments of the present invention provide a performance-adjustable memory module configured for power consumption optimization. In a typical embodiment, the memory module (e.g., a DRAM-type memory module) comprises a set of memory segments coupled to a set of power supplies. A controller (e.g., an external controller) will supply control information via a set of control registers that is used to vary levels of power provided by the set of power supplies to the set of memory segments. The varying levels of power allow for the performance levels of the set of memory segment to be varied, and thus provide a more optimized memory system.

A first aspect of the present invention provides a performance-adjustable memory module, comprising: a set of memory segments; and a set of power supplies coupled to the set of memory segments, the set of memory segments being configured to operate at varying levels of performance levels based on varying levels of power provided via the set of power supplies.

A second aspect of the present invention provides a performance-adjustable memory system, comprising: a plurality of memory segments; a plurality of power supplies coupled to the plurality of memory segments, the plurality of memory segments being configured to operate at varying levels of performance levels based on varying levels of power provided via the plurality of power supplies; and a controller configured to vary the levels of power levels provided by the plurality of power supplies to the plurality of memory segments.

A third aspect of the present invention provides a method for varying levels of performance in a memory module, comprising: providing control information to the memory module from a controller; utilizing the control information to provide varying levels of power provided from a set of power supplies that are coupled to a set of memory segments in the memory module; and varying levels of performance of the set of power segments based on the varying levels of power provided by the set of power supplies.

### BRIEF DESCRIPTION OF THE DRAWINGS

These and other features of this invention will be more readily understood from the following detailed description of the various aspects of the invention taken in conjunction with the accompanying drawings in which:

FIG. 1A depicts a diagram of a memory system according to an embodiment of the present invention.

FIG. 1B depicts an illustrative table of control information utilized by the memory system of FIG. 1A according to an embodiment of the present invention.

FIGS. 2A-B depict illustrative diagrams of performance-adjustable memory modules according to an embodiment of the present invention.

FIG. 3 depicts illustrative address configurations for a performance-adjustable memory module according to an embodiment of the present invention.

FIG. 4 depicts an illustrative power supply configuration to achieve homogeneous performance of a performance-adjustable memory module according to an embodiment of the present invention.

FIGS. 5A-D depict illustrative configurations for achieving varying levels of performance and power consumption according to embodiments of the present invention.

FIG. 6 depicts an illustrative performance-adjustable memory module having a direct memory access (DMA) unit according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Illustrative embodiments will now be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

It will be understood that, although the terms first, second, third, etc. may be used herein to describe various buffers, cores, grades and/or memories, these buffers, cores, grades, and/or memories should not be limited by these terms. These terms are only used to distinguish one buffer, core, grade, or memory from another buffer, core, grade, or memory. Thus, a first buffer, core, grade, or memory discussed below could be termed a second buffer, core, grade, or memory without departing from the teachings of the present inventive concept.

Embodiments are described herein with reference to cross-sectional or perspective illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. For example, an edge or corner region illustrated as having sharp edges may have somewhat rounded or curved features. Likewise, elements illustrated as circular or spherical may be oval in shape or may have certain straight or flattened portions. Thus, the regions illustrated in the figures are schematic in nature and their shapes are not intended to illustrate the actual shape of a region or element of a device and are not intended to limit the scope of the disclosed embodiments.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As indicated above, embodiments of the present invention provide a performance-adjustable memory module configured for power consumption optimization. In a typical embodiment, the memory module (e.g., a DRAM-type memory module) comprises a set of memory segments coupled to a set of power supplies. A controller (e.g., an external controller) will supply control information via a set of control registers that is used to vary levels of power provided by the set of power supplies to the set of memory segments. The varying levels of power allow for the performance levels of the set of memory segment to be varied, and thus provide a more optimized memory system. It is understood that these concepts could be extended and/or implemented at any level of memory architecture hierarchy. For example, similar concepts could be applied at a system and/or card level.

At least some of the teachings described herein utilize concepts of Direct Memory Access (DMA) and/or dynamic random access memory (DRAM). In general, DMA is a feature of modern computers and microprocessors that allows certain hardware subsystems within the computer to access system memory for reading and/or writing independently of the central processing unit. Many hardware systems use DMA including disk drive controllers, graphics cards, network cards, and sound cards. DMA is also used for intra-chip data transfer in multi-core processors, especially in multiprocessor system-on-chips, where its processing element is equipped with a local memory (often called scratchpad memory) and DMA is used for transferring data between the local memory and the main memory. Computers that have DMA channels can transfer data to and from devices with much less CPU overhead than computers without a DMA channel. Similarly, a processing element inside a multi-core processor can transfer data to and from its local memory without occupying its processor time and allowing computation and data transfer concurrency.

Without DMA, using programmed input/output (PIO) mode for communication with peripheral devices, or load/store instructions in the case of multi-core chips, the CPU is typically fully occupied for the entire duration of the read or write operation, and is thus unavailable to perform other work. With DMA, the CPU would initiate the transfer, do other operations while the transfer is in progress, and receive an interrupt from the DMA controller once the operation has been done. This is especially useful in real-time computing applications where not stalling behind concurrent operations is critical.

Dynamic random-access memory (DRAM) is a type of random-access memory that stores each bit of data in a separate capacitor within an integrated circuit. The capacitor can be either charged or discharged; these two states are taken to represent the two values of a bit, conventionally called 0 and 1. Since capacitors leak charge, the information eventually fades unless the capacitor charge is refreshed periodically. Because of this refresh requirement, it is a dynamic memory as opposed to SRAM and other static memory.

The main memory (the “RAM”) in personal computers is dynamic RAM (DRAM). It is the RAM in laptop and workstation computers as well as some of the RAM of video game consoles. The advantage of DRAM is its structural simplicity: only one transistor and a capacitor are required per bit, compared to four or six transistors in SRAM. This allows DRAM to reach very high densities. Unlike flash memory, DRAM is volatile memory (cf. non-volatile memory), since it loses its data quickly when power is removed. The transistors and capacitors used are extremely small. Billions can fit on a single memory chip.

DRAM is usually arranged in a rectangular array of charge storage cells consisting of one capacitor and transistor per data bit. The figure to the right shows a simple example with a 4 by 4 cell matrix. Modern DRAM matrices are many thousands of cells in height and width. The long horizontal lines connecting each row are known as word-lines. Each column of cells is composed of two bit-lines, each connected to every other storage cell in the column (the illustration to the right does not include this important detail). They are generally known as the + and − bit-lines. A sense amplifier is essentially a pair of cross-connected inverters between the bit-lines. A first inverter is connected with input from the + bit-line and output to the − bit-line. A second inverter's input is from the − bit-line with output to the + bit-line. This configuration results in positive feedback which stabilizes after one bit-line is fully at its highest voltage and the other bit-line is at the lowest possible voltage.

In any event, under the embodiments of the present invention, memory may be powered up along multiple levels of power/power supply. Memory response time and data rate is adjusted with the power supply changes. As will be shown below, a single memory module may have multiple memory segments in the memory. Each memory segment or a group of segments may be coupled to an independent power supply. The memory segments adjust response time/latency and date rate with adjustments in power provided by power supplies. Along these lines, memory segments may be differentially manufactured with a design intention such that each memory segment may be mapped to different speed modes. Specifically, low-power memory segments may be utilized for lower-performance operations (e.g., sleep) while high-power memory segments may be used for high-performance operations. To optimize power consumption and or performance within the memory module, memory segment(s) may be deactivated by the controller. In other embodiments, addressing space may be flexibly adjusted to support ultra low-power operation with one or more of the memory segments. Still yet, internal DMA functionality may enable real-time mode switching

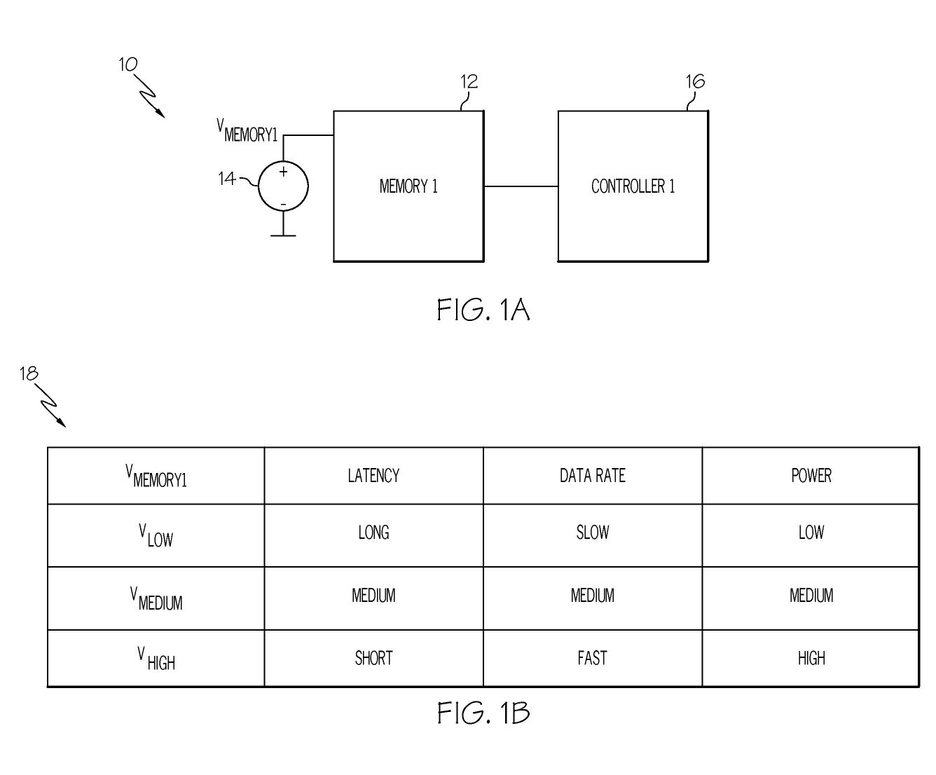

Referring now to FIG. 1A, a memory system 10 according to an embodiment of the present invention is shown. As depicted, system 10 comprises a memory segment 12 coupled to a power supply 14 and controller 16. In, general, memory segment 12 is powered up by a dedicated power supply 14. External controller 16 supplies control information through control registers (both standard and extended) to change the levels of power supplied via power supply 14. This allows for memory response time and data rate to be adjusted along with the power supply change. Under such an embodiment, memory segment 12 power supply may be controlled by the memory segment 12 itself or by external controller 16.

As described above, controller 16 utilizes control information to vary the levels of power provided by power supply 14. FIG. 1B depicts a table 18 of such information. Specifically, table 18 shows an example of power/voltage control plan for speed (latency and data rate) and power target. As shown, power supply 14 may have multiple settings (e.g., low, medium, or high in this example). Each setting has a corresponding latency, data rate, and power consumption setting. Based on the desired goal/target for latency, data rate, and/or power consumption within memory segment 12, the power supply setting may be set at a certain level. It is understood that three power supply settings are shown in FIG. 1B for illustrative purposes only, and that many other settings could be provided hereunder.

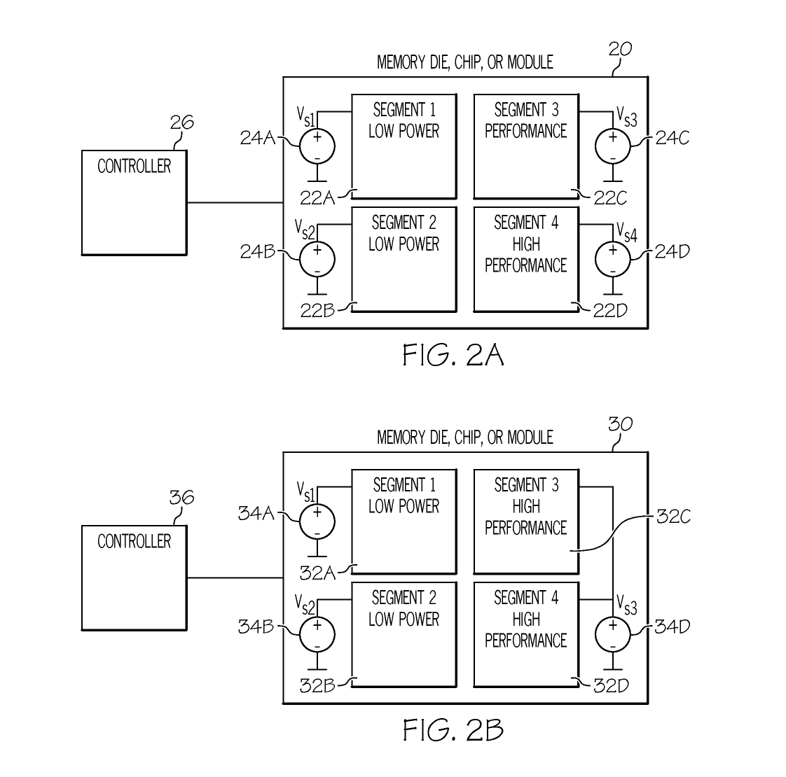

FIGS. 2A-B depict power-adjustable memory systems according to different embodiments of the present invention. As first shown in FIG. 2A, memory module 20 comprises memory segments 22A-D that are each coupled to a separate power supply 24A-D. As indicated above, power supplies 24A-D may be individually controlled by external controller 26 to deliver varying levels of power to memory segments 22A-D so as to achieve varying levels of performance thereby. For example, memory segments 22A-B will receive lower power levels from power supplies 24A-B for lower performance (e.g., sleep modes). Memory segment 22C will receive a medium level of power from power supply 24C for medium level performance (e.g., “normal” operation mode). Memory segment 22D will receive a high level of power from power supply 24D for high level performance (e.g., workload process mode).

FIG. 2B demonstrates that each memory segment need not be coupled to its own independent power supply. Specifically, FIG. 2B shows memory module 30 having memory segments 32A-D, and power supplies 34A-C. As further shown, memory segments 32C-D are configured similarly for higher performance. As such, memory segments 32C-D may be coupled to a common power supply 34C that is likewise configured for high performance (i.e., higher power supplying levels). Similar to FIG. 2A, controller 36 will control power supplies 34A-C to provide power to memory segments 32A-D at the desired levels to achieve the desired performance levels. For example, memory segments 32A-B are configured to receive low power levels (e.g., configured for lower level performance) from power supplies 34A-B, while memory segments 32C-D are configured to receive high power (e.g., configured for higher level performance) from power supply 34C. Although not shown as such, it is understood that since memories segments 32A-B are configured similarly, memory segments 32A-B may also rely on a single “low level” power supply.

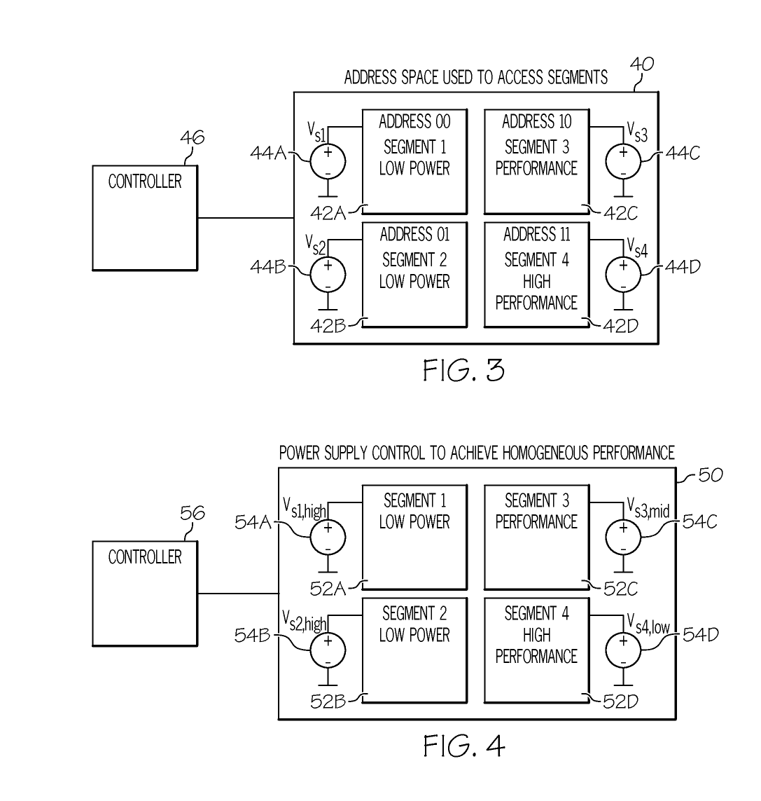

In general, each memory segment or group of memory segments may have their own latency and data rate response. Along these lines, memory segment access may be individually controlled by using individual address space configurations. Referring to FIG. 3, an example of unique addressing configurations is shown. Specifically, memory module 40 is shown having memory segments 42A-D that are coupled to power supplies 44A-D, which are controlled by controller 46. As further shown, each memory segment 42A-D has a unique address assigned thereto. In the example shown the assignments are as follows:
Memory Segment 42A—Address Space 00
Memory Segment 42B—Address Space 01
Memory Segment 42C—Address Space 10
Memory Segment 42D—Address Space 11
   Controller 46 may control memory segments 42A-D individually by referencing their particular address spaces. In a typical embodiment, controller 46 may set corresponding power supplies 44A-D to achieve desired power-performance targets. Memory segments 42A-D may respond to controller 46 with specific speeds at which memory segments 42A-D may operate at given voltage levels. In such an embodiment, memory segment 42A-D's responses may be passive that results in an active reading by controller 46. In providing control of memory module 40, controller 46 may set a predetermined latency and/or data rate per memory segment 42A-D access. Moreover, controller 46 may adjust power/performance (e.g., speed) of memory segments 42A-D in real-time by controller

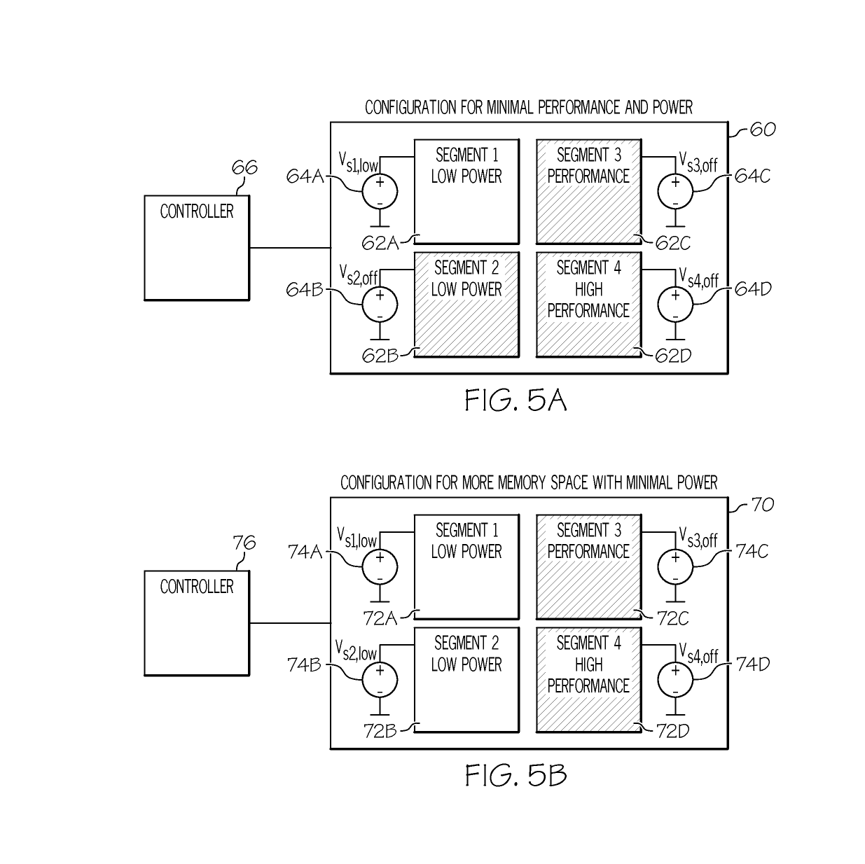

In another embodiment shown in FIG. 4, homogenous speed characteristics may be obtained by adjusting/controlling power supplies 54A-D though system. Similar to the previous FIGS., FIG. 4 depicts a memory module 50 having memory segments 52A-D coupled to power supplies 54A-D, which are controlled by controller 56. To obtain such characteristics, each memory segment should be operated by controller 56 at similar performance levels. Thus, low power/performance segments 52A-B may be subjected to a higher level of power from power supplies 54A-B, medium power/performance memory segment 52C may be subjected to a medium level of power from power supply 54C, while high power/performance memory segment 52D may be subjected to a lower level of power from power supply 54D. Such a configuration may result in a relatively similar and/or equal performance level across memory segments 54A-D.

### ILLUSTRATIVE EXAMPLES

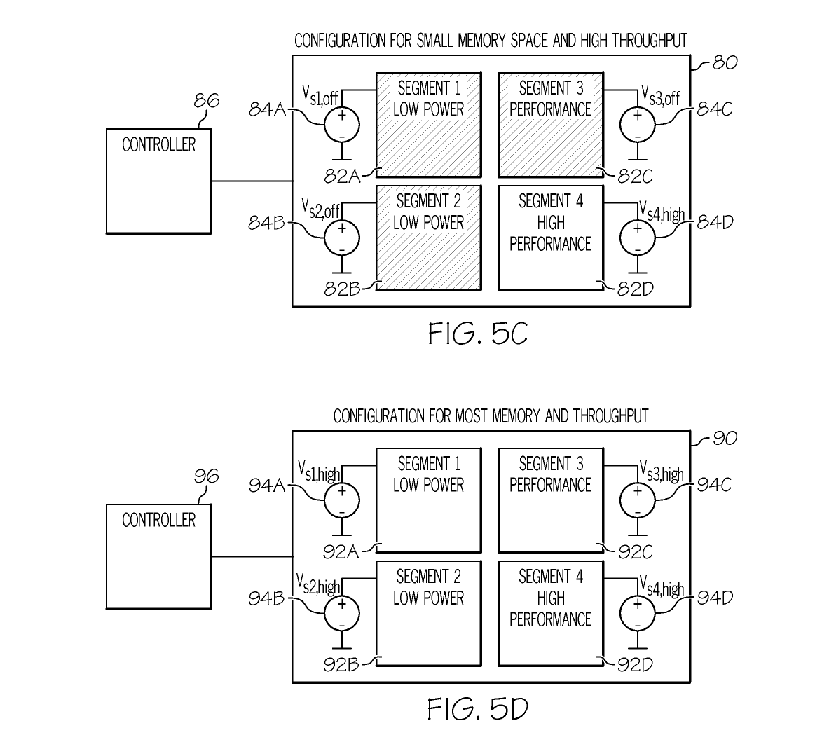

This section will set forth various illustrative examples of different modes and adjustability of performance that the above-described teachings may provide. It is understood that the examples shown and described in conjunction with FIGS. 5A-D are intended to be illustrative only and not intended to be limiting.

Referring to FIG. 5A, a memory module 60 configured for minimal performance and power consumption is shown. As depicted, module 60 comprises memory segments 62A-D coupled to power supplies 64A-D. To achieve the desired configuration, controller 66 will disengage power supplies 64B-D so that only memory segment 62A and power supply 64A remain active.

Referring to FIG. 5B, a memory module 70 configured for additional memory space (as compared to module 60 of FIG. 5A) with minimal power consumption is shown. As depicted, module 70 comprises memory segments 72A-D coupled to power supplies 74A-D. To achieve the desired configuration, controller 76 will disengage power supplies 74C-D (and memory segments 72C-D) so that only memory segments 72A-B and power supplies 74A-B remain active. While there are two memory segments 72A-B active to provide increased memory functionality, both such memory segments 72A-B operate on lower power and thus help conserve power.

Referring to FIG. 5C, a memory module 80 configured for high performance/throughput is shown. As depicted, module 80 comprises memory segments 82A-D coupled to power supplies 84A-D. To achieve the desired configuration, controller 86 will disengage power supplies 84A-C (and memory segments 82A-C) so that only high performance memory segment 82D and power supply 84D remain active. While module 80 may consume more power (e.g., as compared to module 60 of FIG. 5A), module 80's performance (e.g., latency and data rate) will be comparatively better.

Referring to FIG. 5D, a memory module 90 configured for high memory and performance/throughput is shown. As depicted, module 90 comprises memory segments 92A-D coupled to power supplies 94A-D. To achieve the desired configuration, controller 96 will engage all power supplies 94A-D at high levels. This not only provides the highest levels of power to memory segments 92A-D, but results in the highest levels of performance from each memory segment 92A-D.

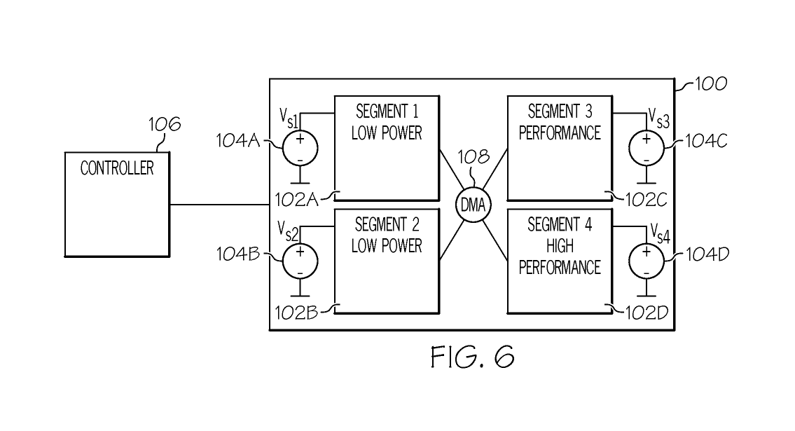

In any of the embodiments described herein, an internal DMA unit may be provided to expedite block-to-block, or segment-to-segment data transfer. As indicated above, DMA enables rapid transitions between high-performance and low-power mode. An example of such a configuration is shown in FIG. 6. As depicted, memory module 100 comprises memory segments 102A-D coupled to power supplies 104A-D (which can be operated via controller 106 in any configuration/fashion in accordance with the teachings recited herein). As further shown, DMA 108 unit is coupled to each memory segment 102A-D to provide for data communication among memory segments 102A-D. DMA unit 108 allows for improved data redundancy and rapid performance mode transition.

In implementation, the various modules described herein might be implemented as discrete modules, or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

While the invention has been particularly shown and described in conjunction with exemplary embodiments, it will be appreciated that variations and modifications will occur to those skilled in the art. For example, although the illustrative embodiments are described herein as a series of acts or events, it will be appreciated that the present invention is not limited by the illustrated ordering of such acts or events unless specifically stated. Some acts may occur in different orders and/or concurrently with other acts or events apart from those illustrated and/or described herein, in accordance with the invention. In addition, not all illustrated steps may be required to implement a methodology in accordance with the present invention. Furthermore, the methods according to the present invention may be implemented in association with the formation and/or processing of structures illustrated and described herein as well as in association with other structures not illustrated. Therefore, it is to be understood that the appended claims are intended to cover all such modifications and changes that fall within the true spirit of the invention.

What is claimed is:

1. A performance-adjustable memory module, comprising:
a set of memory segments; and
a set of power supplies coupled to the set of memory segments, the set of memory segments being configured to operate at varying levels of performance levels based on varying levels of power provided via the set of power supplies.

2. The performance-adjustable memory module of claim 1, further comprising a controller coupled to the performance-adjustable memory module for controlling the set of power supplies to provide the varying levels of performance.

3. The performance-adjustable memory module of claim 2, the controller being configured to provide control information to the performance-adjustable memory module via a set of control registers.

4. The performance-adjustable memory module of claim 3, the control information being utilized to vary the levels of power provided by the set of power supplies to the set of memory segments.

5. The performance-adjustable memory module of claim 1, the set of memory segments comprising a plurality of memory segments.

6. The performance-adjustable memory module of claim 5, the set of power supplies comprising a plurality of power supplies, the each memory segment of the plurality of memory segments being coupled to at least one power source of the plurality of power supplies.

7. The performance-adjustable memory module of claim 1, the set of memory segments each being assigned a unique address.

8. The performance-adjustable memory module of claim 1, the varying levels of performance being determined based on target latencies and data rates within the set of memory segments.

9. A performance-adjustable memory system, comprising:
a plurality of memory segments;
a plurality of power supplies coupled to the plurality of memory segments, the plurality of memory segments being configured to operate at varying levels of performance levels based on varying levels of power provided via the plurality of power supplies; and
a controller configured to vary the levels of power levels provided by the plurality of power supplies to the plurality of memory segments.

10. The performance-adjustable memory module of claim 9, the controller being configured to provide control information to the performance-adjustable memory module via a plurality of control registers.

11. The performance-adjustable memory module of claim 10, the control information being utilized to vary the levels of power provided by the plurality of power supplies to the plurality of memory segments.

12. The performance-adjustable memory module of claim 9, each memory segment of the plurality of memory segments being coupled to at least one power source of the plurality of power supplies.

13. The performance-adjustable memory module of claim 9, the plurality of memory segments each being assigned a unique address.

14. The performance-adjustable memory module of claim 9, the varying levels of performance being determined based on target latencies and data rates within the set of memory segments.

15. A method for varying levels of performance in a memory module, comprising:
providing control information to the memory module from a controller;
utilizing the control information to provide varying levels of power provided from a set of power supplies that are coupled to a set of memory segments in the memory module; and
varying levels of performance of the set of power segments based on the varying levels of power provided by the set of power supplies.

16. The method of claim 15, the controller providing the control information via a set of control registers.

17. The method of claim 15, the set of memory segments comprising a plurality of memory segments.

18. The method of claim 17, the set of power supplies comprising a plurality of power supplies, the each memory segment of the plurality of memory segments being coupled to at least one power source of the plurality of power supplies.

19. The method of claim 15, the set of memory segments each being assigned a unique address.

20. The method of claim 15, the varying levels of performance being determined based on target latencies and data rates within the set of memory segments.
